(19) United States
(12) Patent Application Publication
(10) Pub. No.: US 2009/0320076 A1
(43) Pub. Date: Dec. 24, 2009

(54) System and Method for Processing an Interactive Advertisement

(75) Inventor: Hisao M. Chang, Cedar Park, TX (US)

Correspondence Address: AT&T Legal Department - LNA;Attn: Patent Docketing, Room 2A- 207, One AT & T Way, Bedminster, NJ, 07921, US

(73) Assignee: AT&T INTELLECTUAL PROPERTY I, L.P., Reno, NV (US)

(21) Appl. No.: 12/143,526

(22) Filed: Jun. 20, 2008

(51) Int. Cl. G06F 13/00; H04N 5/44; G10L 21/00

(52) U.S. Cl. 725/60; 348/734; 704/270.1; 348/E05.103; 704/E21.001

(57) ABSTRACT

A set-top box device comprises a speech recognition module, a video image recognition module, and a voice over Internet protocol bridge. The speech recognition module is configured to perform speech recognition on a voice command signal to determine an action to take in the set-top box device. The video image recognition module is connected to the speech recognition module, and is configured to recognize a display device image. The voice over Internet protocol bridge is coupled to the video image recognition module, and is configured to connect a voice telephone call from the set-top box device to a call center.

### FIELD OF THE DISCLOSURE

The present disclosure generally relates to communications networks, and more particularly relates to a system and method for processing an interactive advertisement.

### BACKGROUND

Television programs usually have commercial breaks that consist of a number of different commercials that can vary in length. The commercials can display a telephone number and/or a website associated with an entity featured in the commercial. If an individual watching the commercial wants to find out more information about the entity, or order an advertised product, then the individual has to remember the telephone number or website displayed, in order to initiate contact with the entity.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an Internet Protocol Television (IPTV) network;

FIG. 2 is a plan view of a remote control device;

FIG. 3 is a block diagram of a plurality of components in the remote control device;

FIG. 4 is a block diagram of a portion of a set-top box device;

FIG. 5 is an exemplary screen shot of an interactive commercial displayed on a television;

FIG. 6 is a flow diagram of a method for communicating with a company associated with the interactive commercial;

FIG. 7 is a flow diagram of a method for providing a telephone call through the set-top box device; and

FIG. 8 is a flow diagram of a method for providing an interactive video catalog through the set-top box device.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

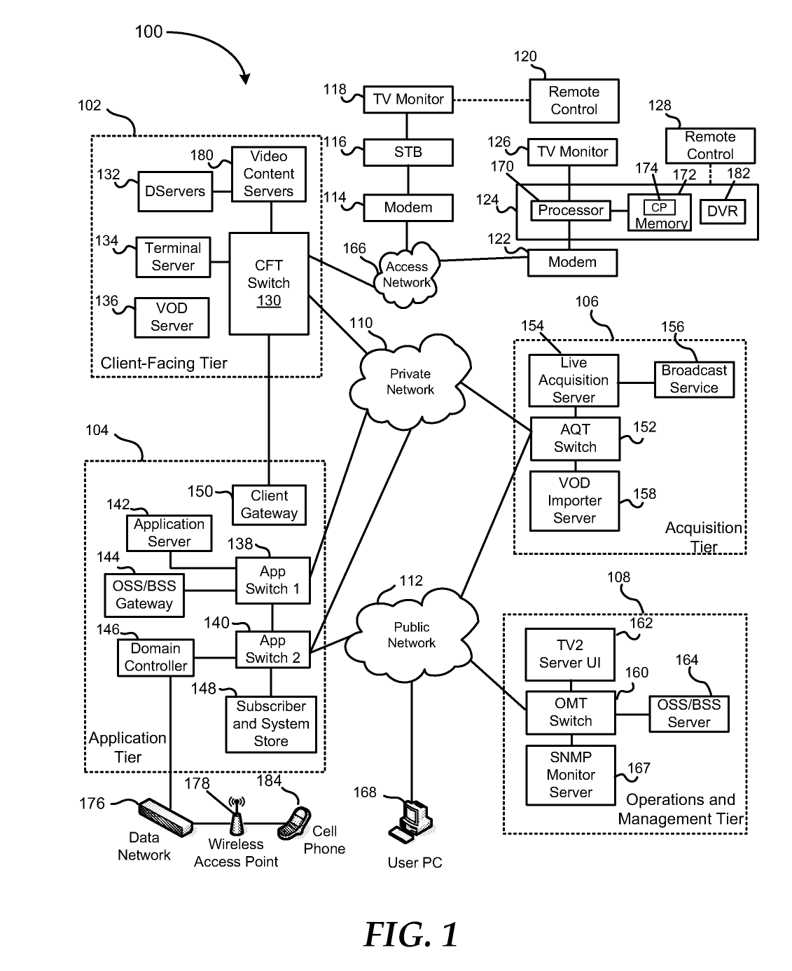

FIG. 1 shows an IPTV system 100 including a client facing tier 102, an application tier 104, an acquisition tier 106, and an operations and management tier 108. Each tier 102, 104, 106, and 108 is coupled to one or both of a private network 110 and a public network 112. For example, the client-facing tier 102 can be coupled to the private network 110, while the application tier 104 can be coupled to the private network 110 and to the public network 112 such as the Internet. The acquisition tier 106 can also be coupled to the private network 110 and to the public network 112. Moreover, the operations and management tier 108 can be coupled to the public network 112.

The various tiers 102, 104, 106 and 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

The client-facing tier 102 can communicate with user equipment via a private access network 166, such as an Internet Protocol Television (IPTV) network. In an illustrative embodiment, modems such as a first modem 114 and a second modem 122 can be coupled to the private access network 166. The client-facing tier 102 can communicate with a first representative set-top box device 116 via the first modem 114 and with a second representative set-top box device 124 via the second modem 122. The client-facing tier 102 can communicate with a large number of set-top boxes over a wide geographic area, such as a regional area, a metropolitan area, a viewing area, or any other suitable geographic area that can be supported by networking the client-facing tier 102 to numerous set-top box devices. In one embodiment, the client-facing tier 102 can be coupled to the modems 114 and 122 via fiber optic cables. Alternatively, the modems 114 and 122 can be digital subscriber line (DSL) modems that are coupled to one or more network nodes via twisted pairs, and the client-facing tier 102 can be coupled to the network nodes via fiber-optic cables. Each set-top box device 116 and 124 can process data received from the private access network 166 via an IPTV software platform such as Microsoft® TV IPTV Edition.

The first set-top box device 116 can be coupled to a first display device 118, such as a first television monitor, and the second set-top box device 124 can be coupled to a second display device 126, such as a second television monitor. Moreover, the first set-top box device 116 can communicate with a first remote control 120, and the second set-top box device can communicate with a second remote control 128. In an exemplary, non-limiting embodiment, each set-top box device 116 and 124 can receive data or video from the client-facing tier 102 via the private access network 166 and render or display the data or video at the display device 118 or 126 to which it is coupled. The set-top box devices 116 and 124 thus may include tuners that receive and decode television programming information for transmission to the display devices 118 and 126. Further, the set-top box devices 116 and 124 can include a set-top box processor 170 and a set-top box memory device 172 that is accessible to the set-top box processor. In a particular embodiment, the set-top box devices 116 and 124 can also communicate commands received from the remote controls 120 and 128 back to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand material. The CFT switch 130 can also be coupled to a terminal server 134 that provides terminal devices, such as a game application server and other devices with a common connection point to the private network 110. In a particular embodiment, the CFT switch 130 can also be coupled to a video-on-demand (VOD) server 136.

The application tier 104 can communicate with both the private network 110 and the public network 112. In this embodiment, the application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the set-top box devices 116 and 124 through the CFT switch 130 via the private access network 166, so the set-top box devices 116 and 124 can provide functions such as display, messaging, processing of IPTV data and VOD material. In a particular embodiment, the OSS/BSS gateway 144 includes operation systems and support (OSS) data, as well as billing systems and support (BSS) data.

The second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116 and 124 can access the system via the private access network 166 using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices, from accessing the private network 110 by denying access to these devices beyond the private access network 166.

For example, when the set-top box device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138, to the second APP switch 140, and the second APP switch 140 can communicate the query across the public network 112 to the OSS/BSS server 164. After the client gateway 150 confirms subscriber and/or billing information, the client gateway 150 can allow the set-top box device 116 access to IPTV content and VOD content. If the client gateway 150 cannot verify subscriber information for the set-top box device 116, such as because it is connected to a different twisted pair, the client gateway 150 can deny transmissions to and from the set-top box device 116 beyond the private access network 166.

The acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives television content, for example, from a broadcast service 156. Further, the AQT switch can be coupled to a video-on-demand importer server 158 that stores television content received at the acquisition tier 106 and communicate the stored content to the client-facing tier 102 via the private network 110.

The operations and management tier 108 can include an operations and management tier (OMT) switch 160 that conducts communication between the operations and management tier 108 and the public network 112. In the illustrated embodiment, the OMT switch 160 is coupled to a TV2 server 162. Additionally, the OMT switch 160 can be coupled to an OSS/BSS server 164 and to a simple network management protocol (SNMP) monitor 167 that monitors network devices. In a particular embodiment, the OMT switch 160 can communicate with the AQT switch 152 via the public network 112.

In a particular embodiment during operation of the IPTV system, the live acquisition server 154 can acquire television content from the broadcast service 156. The live acquisition server 154 in turn can transmit the television content to the AQT switch 152 and the AQT switch can transmit the television content to the CFT switch 130 via the private network 110. Further, the television content can be encoded at the D-servers 132, and the CFT switch 130 can communicate the television content to the modems 114 and 122 via the private access network 166. The set-top box devices 116 and 124 can receive the television content from the modems 114 and 122, decode the television content, and transmit the content to the display devices 118 and 126 according to commands from the remote control devices 120 and 128.

Additionally, at the acquisition tier 106, the VOD importer server 158 can receive content from one or more VOD sources outside the IPTV system 100, such as movie studios and programmers of non-live content. The VOD importer server 158 can transmit the VOD content to the AQT switch 152, and the AQT switch 152 in turn can communicate the material to the CFT switch 130 via the private network 110. The VOD content can be stored at one or more servers, such as the VOD server 136.

When a user issues a request for VOD content to the set-top box device 116 or 124, the request can be transmitted over the private access network 166 to the VOD server 136 via the CFT switch 130. Upon receiving such a request, the VOD server 136 can retrieve requested VOD content and transmit the content to the set-top box device 116 or 124 across the private access network 166 via the CFT switch 130. In an illustrative embodiment, the live acquisition server 154 can transmit the television content to the AQT switch 152, and the AQT switch 152 in turn can transmit the television content to the OMT switch 160 via the public network 112. In this embodiment, the OMT switch 160 can transmit the television content to the TV2 server 162 for display to users accessing the user interface at the TV2 server. For example, a user can access the TV2 server 162 using a personal computer (PC) 168 coupled to the public network 112.

The domain controller 146 communicates with the public network 112 via the second APP switch 140. Additionally, the domain controller 146 can communicate via the public network 112 with the PC 168. For example, the domain controller 146 can display a web portal via the public network 112 and allow users to access the web portal using the PC 168. Further, in an illustrative embodiment, the domain controller 146 can communicate with at least one wireless network access point 178 over a data network 176. In this embodiment, each wireless network access device 178 can communicate with user wireless devices such as a cellular telephone 184.

In a particular embodiment, the set-top box devices can include a set-top box computer program 174 that is embedded within the set-top box memory device 172. The set-top box computer program 174 can contain instructions to receive and execute at least one user television viewing preference that a user has entered by accessing an Internet user account via the domain controller 146. For example, the user can use the PC 168 to access a web portal maintained by the domain controller 146 via the Internet. The domain controller 146 can query the subscriber and system store 148 via the private network 110 for account information associated with the user. In a particular embodiment, the account information can associate the user's Internet account with the second set-top box device 124. For instance, in an illustrative embodiment, the account information can relate the user's account to the second set-top box device 124 by associating the user account with an IP address of the second set-top box device, with data relating to one or more twisted pairs connected with the second set-top box device, with data related to one or more fiber optic cables connected with the second set-top box device, with an alphanumeric identifier of the second set-top box device, with any other data that is suitable for associating the second set-top box device with a user account, or with any combination of these.

The set-top box computer program 174 can contain instructions to receive many types of user preferences from the domain controller 146 via the access network 166. For example, the set-top box computer program 174 can include instructions to receive a request to record at least one television program at a video content storage module such as a digital video recorder (DVR) 182 within the second set-top box device 124. In this example embodiment, the set-top box computer program 174 can include instructions to transmit the request to the DVR 182, where the television program(s) are recorded. In an illustrative embodiment, the set-top box computer program 174 can include instructions to receive from the DVR 182 a recording status with respect to one or more of the television programs and to transmit at least one message regarding the status to a wireless device, such as the cellular telephone 184. The message can be received at the CFT switch 130, for instance, and communicated to the domain controller 146 across the private network 110 via the second APP switch 140. Further, the domain controller 146 can transmit the message to the data network 176, directly or via the public network 112, and on to the wireless network access point 178. The message can then be transmitted to the cellular telephone 184. In an illustrative embodiment, the status can be sent via a wireless access protocol (WAP).

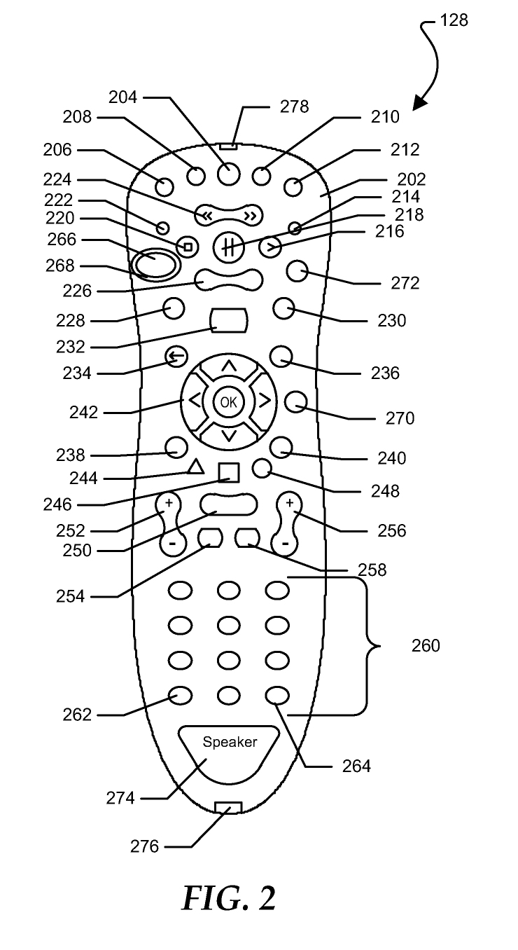

FIG. 2 shows the remote control device 128 including a housing 202 having a plurality of buttons. For example, the remote control device 128 can include a power button 204, an IPTV button 206, a television (TV) button 208, a digital video disc (DVD) button 210, and an auxiliary (AUX) button 212. When the IPTV button 206 is pressed, the remote control device 128 can be used to control the set-top box device 124. When the TV button 208 is pressed, the remote control device 206 can be used to control the display device 126 connected to the set-top box device 124. When the DVD button 210 is pressed, the remote control device 128 can be used to control a DVD player connected to the display device 126 or to the set-top box device 124. Additionally, when the AUX button 212 is pressed, the remote control device 128 can be used to control an auxiliary device connected to the display device 126 or to the set-top box device 124. For example, the auxiliary device can be a compact disc (CD) player, a video cassette recorder (VCR), an audio receiver, or some other home entertainment device.

The remote control device 128 can include a TV/VIDEO button 214 that can be used to toggle between inputs for display, such as between television content and video content from the DVR or the DVD player. The remote control device 128 can also include a PLAY button 216, a PAUSE button 218, a STOP button 220, a RECORD button 222, a rewind (REW)/fast forward (FF) button 224, and a replay/slow forward (FWD) button 226. These buttons can be used to control the content received at the set-top box device 124 or video content received from a DVD player. One or more of these buttons can also be programmed to control the CD player, the VCR, or some other home entertainment device. The remote control device 128 can also include a VIDEO ON DEMAND button 228 and a RECORDED TV button 230. The VIDEO ON DEMAND button 228 can be pressed in order to access VOD content available via the set-top box device 124. The RECORDED TV button 230 can be pressed in order to access television content recorded at the set-top box device 124.

The remote control device 128 can also include a MENU button 232, a BACK button 234, a GO INTERACTIVE button 236, an EXIT button 238, and an INFO button 240. The MENU button 232 can be used to access a menu of features provided by the set-top box device 124. Further, the INFO button 244 can be used to access an information window provided by the set-top box device 124. The GO INTERACTIVE button 236 can be used to access interactive content provided by the IPTV system. The remote control device 128 can include a directional keypad 242. The directional keypad 242, the BACK button 234, and the EXIT button 238 can be used to navigate within the various content windows provided by the set-top box device 124. The remote control device 128 can also include a triangular A button 244, a square B button 246, and a round C button 248. The A button 244, the B button 246, and the C button 248 can be used to make various selections when navigating within a menu screen, an information screen, or some other screen provided by the set-top box device 124.

The remote control device 128 can further include a GUIDE button 250 that can be pressed in order to access an electronic programming guide for the content provided by the set-top box device 124. Moreover, the remote control device 128 can include a volume (VOL) up/down button 252, a MUTE button 254, a channel/page (CH/PG) up/down button 256, and a LAST button 258. The VOL button 252 can be used to control the volume of the set-top box device 124, a TV, a CD player, etc. The MUTE button 254 can be used to mute audio content provided by the set-top box device 124, a TV, a CD player, etc. The CH/PG button 256 can be used to change the channel at the set-top box device 124 or navigate from page-to-page within a content guide provided by the set-top box device. The LAST button 258 can be used to return to the last channel viewed by the user at the set-top box device 124.

The remote control device 128 can include a numerical keypad 260 having a plurality of buttons that are individually numbered 1, 2, 3, 4, 5, 6, 7, 8, 9, and 0. The numerical keypad 260 is configured similar to a telephone keypad and each individual button also includes a portion of the alphabet. The 2 button includes ABC, the 3 button includes DEF, the 4 button includes GHI, the 5 button includes JKL, the 6 button includes MNO, the 7 button includes PQRS, the 8 button includes TUV, and the 9 button includes WXYZ. The 0 button can also be used as a SPACE button. In a particular embodiment, the numerical keypad 260 can be used to input a specific channel number. Further, the numerical keypad 260 can be used to input text to the IPTV system, when necessary, using the triple tap method well known in the art. The numerical keypad 260 can also include a DELETE button 262 and an ENTER/ZOOM button 264.

The remote control device 128 can also include a microphone 266, a light emitting diode (LED) annulus 268, a talk button 270, an optical distance measurer 272, a speaker 274, an audio output 276, and an infrared (IR) transmitter 278. Further details of the remote control device 128 are described in U.S. patent application Ser. No. 11/847,120, the disclosure of which is hereby incorporated by reference.

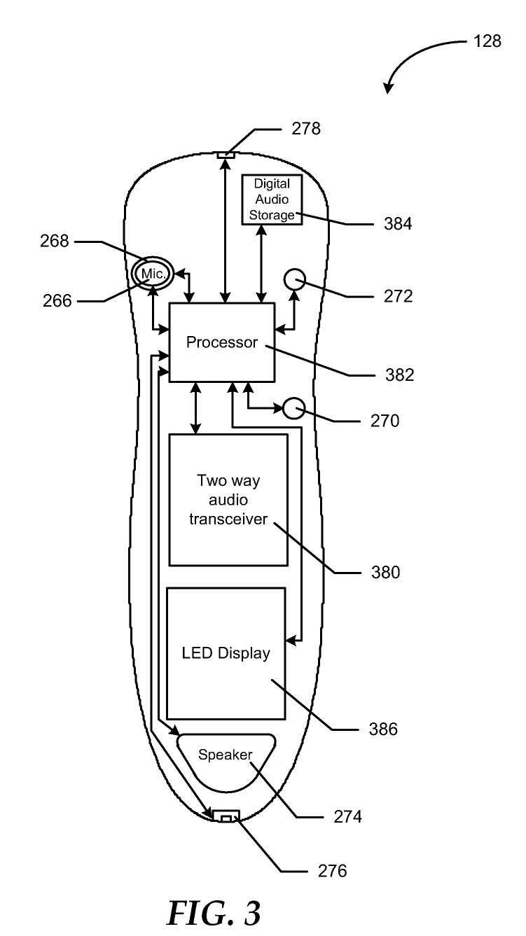

FIG. 3 shows a block diagram of a number of components in the remote control device 128 including a two-way audio transceiver 380, a processor 382, a digital audio storage 384, and a LED display 386. The microphone 266 is coupled to the digital audio storage 384 through the processor 382. The LED annulus 268 is coupled to the talk button 270 and the two-way audio transceiver 380. The talk button 270 is coupled to the two-way audio transceiver 380 and to the digital audio storage 384 through the processor 382. The optical distance measurer 272 is coupled to the two-way audio transceiver 380. The speaker 274 is coupled to the two-way audio transceiver 380. The audio output 276 is coupled to the two-way audio transceiver 380. The IR transmitter 278 is in communication with the processor 382. The two-way audio transceiver 380 is in communication with the processor 382. The digital audio storage 384 is in communication with the processor 382. The LED display 386 is in communication with the processor 382.

The microphone 266 can be used to receive an audio input from the user of the remote control device 128. Upon the talk button 270 being pressed, the remote control device can transmit the audio input to the set-top box device 124. The LED annulus 268 can light-up, indicating that the talk button 270 has been pressed and the remote control device 128 is transmitting the audio input to the set-top box device 124. The optical distance measurer 272 can determine a distance that the user is from the remote control device 128, such as by transmitting a reflective optical beam from the remote control device. The speaker 274 can output a digital audio signal received by the remote control device 128 from the set-top box device 124. The audio output 276 can output, to an external audio device (not shown), the digital audio signal received by the remote control device 128 from the set-top box device 124. The IR transmitter 278 can transmit IR control signals to the auxiliary devices. The IR control signals can be used to perform various functions on any of the auxiliary devices, such as changing the channel, changing the volume level, and the like on the set-top box 124.

Whenever any button is pressed on the remote control device 128, such as channel up/down buttons 256 of FIG. 2, the digital audio storage 384 activates and records an audio input received at the microphone 266. The audio input is stored in a local audio circular buffer of the digital audio storage 384 for a predetermined amount of time. The predetermined amount of time can be any length of time, for example five seconds. Additionally, upon a button being pressed on the remote control device 128, the two-way audio transceiver 380 activates such that the audio input can be transmitted to the set-top box device 124. The two-way audio transceiver 380 can alternatively be placed in a sleep mode to conserve battery life if no button is pressed for a predetermined period, such as fifteen seconds. Upon the talk button 270 being pressed, the remote control device 128 can execute a number of functions at substantially the same time. The remote control device 128 can set the recording mode to “start,” light-up the LED annulus 268, activate the audio digital storage 384, activate the two-way audio transceiver 380, and trigger the optical distance measurer 272 to determine a distance between the remote control device 128 and the user's face.

When the recording mode is set to “start,” the remote control device 128 can send the last audio input stored in the local audio circular buffer of the digital audio storage 384 to the set-top box device 124. At substantially the same time, the remote control device 128 can send a control parameter embedded in a radio frequency (RF) control signal to the set-top box device 124. The control parameter can contain the distance measurement determined by the optical distance measurer 272, such as four and one-half inches. Based on the control parameter associated with the distance measurement received from the remote control device 128, the set-top box device 124 can automatically adjust level of audio amplification for the audio input received. The adjustment level of the audio amplification can compensate for a variability that the user's mouth is too far away from the microphone 266 or too close to it. Finally, the remote control device can change the recording mode to “on.”

When the recording mode is “on,” the microphone 266 can continue to receive the audio input and the two-way audio transceiver 380 can send it as a digital audio stream to the set-top box device 124. Upon receiving the digital audio stream, the set-top box device 124 can stream the digitized audio packets to the multimedia application server 142 over the private network 110 of FIG. 1. The multimedia application server 142 can process the speech input and/or pass it in real time to a voice search engine, where the audio input can be used to perform a voice search for a specific television program. Upon receiving the end of the audio input, the multimedia application server 142 can send a control message to the set-top box device 124 indicating the end of a speech input session.

Upon receiving the end of speech input from multimedia application server 142, the set-top box device 124 can present a visual icon on the display device 126 of FIG. 1, such as displaying a muted microphone icon, indicating that the end of the speech input is reached. At substantially the same time, the set-top box device 124 can send an RF control signal to the remote control device 128 indicating the end of the speech input. Upon receiving the RF control signal from the set-top box device 124, the remote control device 128 can change the recording mode from “on” to “off.” Additionally, the remote control device 128 can set the recording mode to “off” if a predetermined amount of time, such as two seconds, elapses after talk button 270 has been released and the audio input level is below a predetermined level. When the recording mode is changed from “on” to “off,” the remote control device 128 can turn off the LED annulus 268, and set the microphone 266 and two-way audio transceiver 380 to sleep modes to conserve the battery.

The multimedia application server 142 can also send a control message to the set-top box device 124, requesting that the set-top box device send a variety of RF-based control signals to the remote control device 128. For example, one control signal can cause the remote control device 128 to play a short audio file stored on the digital audio storage 384 through the speaker 274. This feature can enable the user to locate the remote control device 128 if it is missing. Another control signal can cause the remote control device 128 to turn off the LED annulus 268 and to end transmission of the audio input. The multimedia application server 142 can also send a “play list” to the remote control device 128 via the set-top box device 124. The play list can contain a set of channel numbers, which can be stored on the remote control device 128. This feature can be used to select a number of “favorite” broadcast channels by scrolling the list stored on the remote control device 128 via the LED display 386.

Also, the set-top box device 124 can automatically scan the RF band over which the remote control device 128 is operating, such as two and two-fifths GHz. If there is any RF interference from other RF devices in a surrounding area, the set-top box device 124 can automatically choose an RF channel with less interference and then send a control signal to the remote control device 128. The control signal can request that the remote control device re-synchronize the signal band with the set-top box device 124.

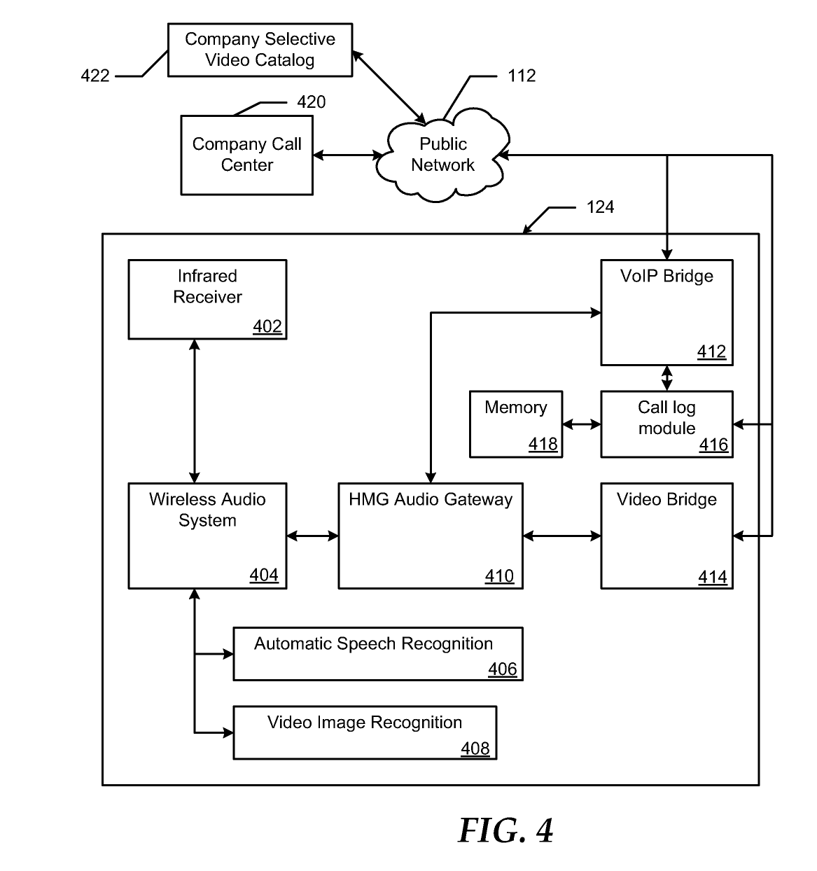

FIG. 4 shows a block diagram of the set-top box device 124 including an infrared receiver 402, a wireless audio system 404, a speech recognition module 406, a video image recognition module 408, a home media gateway (HMG) audio gateway 410, a voice over Internet protocol (VoIP) bridge 412, a video bridge 414, a call log module 416, and a memory 418. The infrared receiver 402 is in communication with the wireless audio system 404. The wireless audio system is in communication with the speech recognition module 406, with the video image recognition module 408, and with the HMG audio gateway 410. The speech recognition module 406 is in communication with the video image recognition module 408. The HMG audio gateway 410 is in communication with the VoIP bridge 412 and with the video bridge 414. The VoIP bridge 412 is in communication with a company call center 420 through the public network 112. The video bridge 414 is in communication with a company selective video catalog 422 through the public network 112. The call log module 416 is in communication with the VoIP bridge 412 and with the memory 418.

The infrared receiver 402 can receive control signals from the IR transmitter 178 of the remote control device 128. The infrared receiver 402 can transmit the control signal to another portion of the set-top box device 124 to perform a specific function, such as changing the channel, changing the volume, or the like. The wireless audio system 404 can transmit different radio frequency (RF) signals between the set-top box device 124 and the remote control device 128. The speech recognition module 406 receives a voice command signal, and determines an associated control function requested. The video image recognition module 408 determines a telephone number or a website associated with a currently displayed advertisement.

During operation, the infrared receiver 402 can receive an IR control signal from the remote control device 128 indicating that the talk button 270 is pressed. Upon receiving the IR control signal, a freeze frame can be taken of the currently displayed commercial. The wireless audio system 404 can receive the voice command signal from the two-way audio transceiver 380 of the remote control device 128. The voice command signal is transmitted to the automatic speech recognition module 406, and speech recognition is performed on the voice command signal to determine the control function requested. In an embodiment, the user can request to call the company advertising in the commercial, or can request to find out more information about the company.

Depending on the control signal requested, the HMG audio gateway 410 can either initiate a VoIP telephone call or initiate a video stream connection. If the control signal is a request to call an entity, the HMG audio gateway 410 can initiate a two-way narrow bandwidth audio path. The entity can be an individual, a non-profit organization, a government agency, and the like. The entity will be referred to hereafter as the company. However, if the control signal is a request to find out more information about the company, the HMG audio gateway 410 can initiate a two-way wide bandwidth video path.

The VoIP bridge 412 can be used to connect a VoIP telephone call to the company. The video bridge 414 can be used to connect a video conference with the video catalog of the company. The call log module 416 can receive a call log for the VoIP telephone calls made by the set-top box device 124. The call log can include the date and time that the VoIP telephone call was made. Additionally, the call log module 416 can upload the call log to a server of a company associated with a telephone number in the call log at a predetermined interval. The predetermined interval can be daily, monthly, quarterly, and the like. The memory 416 can store the call logs until the predetermined interval is reached.

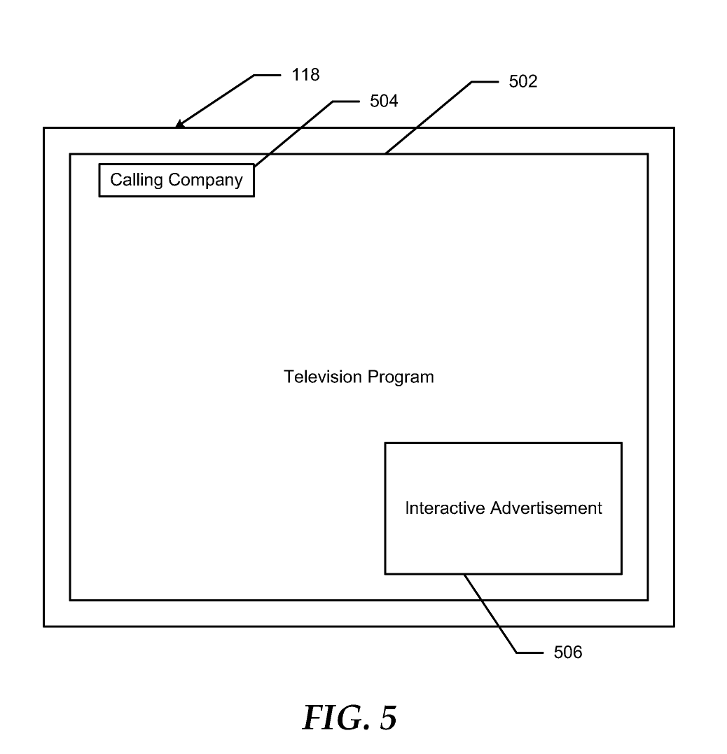

If the user wants to call the company, the video image recognition module 408 performs video recognition on the freeze frame of the commercial to determine a telephone number displayed on the commercial. The video recognition can be performed through the process disclosed in U.S. patent application Ser. No. 12/102,310 filed Apr. 14, 2008, the disclosure of which is hereby incorporated by reference. The video image recognition module 408 can transmit the telephone number to the HMG audio gateway 410, which can initiate a narrow band communication channel with the company call center 420 through the VoIP bridge 412. While the VoIP telephone call is being placed, the set-top box device 124 can output a text string to the display device 118 of FIG. 1 indicating that the set-top box is calling the company. The text string can be displayed on a display 502 in a text box 504, similar to an on-screen caller identification box, as shown in FIG. 5.

Additionally, the call log module 416 can receive time stamp information about the VoIP telephone call from the VoIP bridge 412, and the call log module can store the time stamp information as a call log in the memory 418. The call log module 416 can also transmit the call log information to a server of the company over the public network 112 at predetermined intervals, such as daily, weekly, monthly, and the like. The company can use the call log information to determine if the telephone call was made as a result of the commercial. For example, the company can use the time and date of the VoIP telephone call, as recorded in the call log, to determine if the telephone call was made at the time that the commercial was output by the IPTV system 100.

Upon the VoIP telephone call being connected, the wireless audio system 404 of the set-top box device 124 can transmit audio signals received from the company call center 420 to the two-way audio transceiver 380 of the remote control device 128, and the audio signal can be output to the user through the speaker 274 or the audio output 276. Thus, the user can utilize the remote control device 128 to have a telephone conversation with a customer service representative at the company call center 420. The user can press the talk button 270 on the remote control device 128, talk into the microphone 266, and the audio input can be transmitted by the two-way audio transceiver 380 to the wireless audio system 404. The HMG audio gateway 410 can retransmit what the user said to the company call center 420.

If the control function requested is to find out more information about the company, the video image recognition module 408 determines a website address displayed on the freeze frame of the commercial. The website address is transmitted to the HMG audio gateway 410 which can initiate a wide bandwidth communication with the company selective video catalog 422 through the video bridge 414 and through the public network 112. Upon the communication being initiated with the company selective video catalog 422, the video bridge 414 outputs a video stream, representing the video catalog, to the display device 118. The video stream can be combined with the current video stream received from the IPTV system 100 and can be displayed in an interactive advertisement portion 506 of the display 502 as shown in FIG. 5. The interactive advertisement portion 506 can be similar to a picture-in-picture display on televisions.

The user can utilize the remote control device 128 to scroll through the company selective video catalog 422, to enter voice command searches in the company selective video catalog, and the like. While the video bridge 414 has been discussed with respect to the company selective video catalog 422, it should be understood that the video bridge can connect to any company server that can provide an interactive customer experience for the user of the set-top box 124 and the remote control device 128.

Additionally, the set-top box device 124 can concurrently communicate with the company through the VoIP bridge 412 and the video bridge 414. For example, if the user initiates a voice command to communicate with the company, the video image recognition module 408 can recognize both the telephone number and website address displayed on the freeze frame and store them locally in the set-top box device 124. Then depending on the voice command received, the set-top box device 124 can then use either the telephone number or the website address to communicate with the company. If the user wanted to find out more information about the company, then the HMG audio gateway 410 can communicate with the company selective video catalog 422 through the video bridge 414 as stated above.

Then, while browsing the company selective video catalog 422 the user can send the voice command to call the company. The HMG audio gateway 410 can then retrieve the telephone number and can initiate a narrow band communication channel with the company call center 420 through the VoIP bridge 412 while the video communication is still open through the video bridge 414. The user can then terminate either communication channel by sending an associated voice command to the set-top box device 124. Upon both communication channels being terminated, the set-top box device 124 can erase the telephone number and the website address associated with the company.

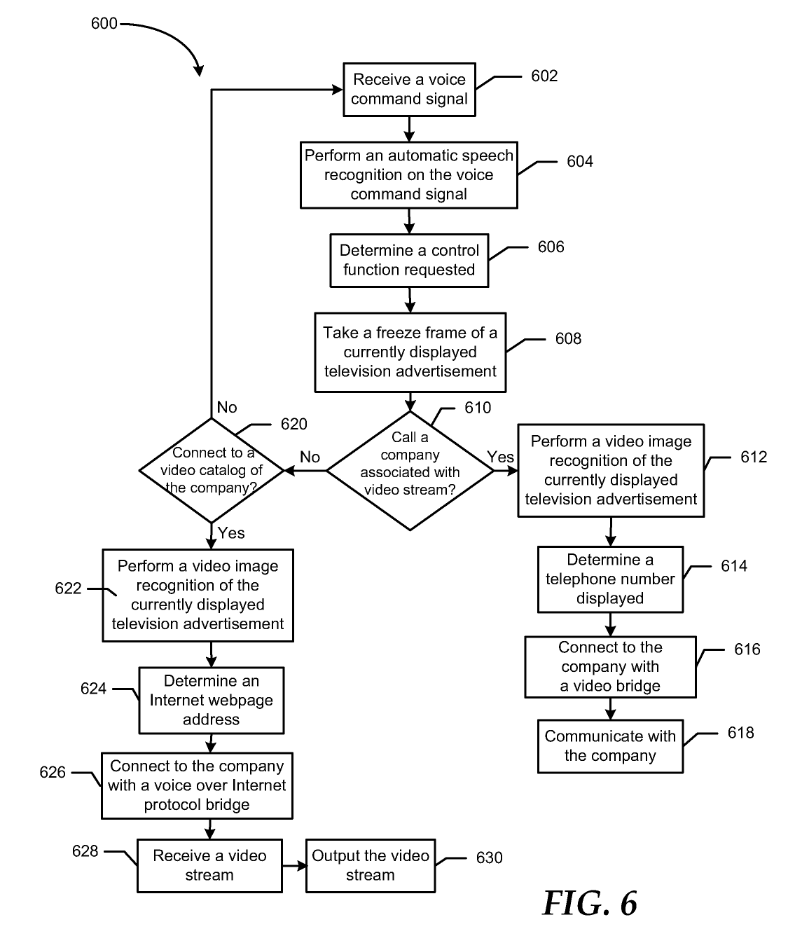

The set-top box 124 can enable the user to communicate with a company associated with an interactive advertisement. FIG. 6 shows a flow diagram of a method 600 for communicating with a company associated with an interactive advertisement. At block 602, a voice command signal is received. Automatic speech recognition is performed on the voice command signal at block 604. At block 606, a control function requested is determined. A freeze frame of a currently displayed video stream is taken at block 608. The video stream can be an Internet protocol television advertisement. At block 610, a determination is made whether the control function requested is to call a company associated with the television advertisement.

If the control function requested is to call the company, video image recognition of the currently displayed video stream is performed at block 612. At block 614, a telephone number displayed on the video stream is determined. The set-top box device is connected to the company through a voice over Internet protocol bridge at block 616. At block 618, the set-top box communicates with the company associated with the currently displayed video stream.

At block 620, if the control function requested is not to call the company, a determination is made whether the control function requested is to find out more information about the company. If the control function requested is not to find out more information about the company, then the flow diagram continues as stated above at block 602. If the control function requested is to find out more information about the company, then video image recognition is performed at block 622. At block 624, an Internet webpage address is determined. The set-top box device is connected to the video catalog of the company through a video bridge at block 626. At block 628, a video stream is received at the set-top box device. The video stream is output to a display device at block 630.

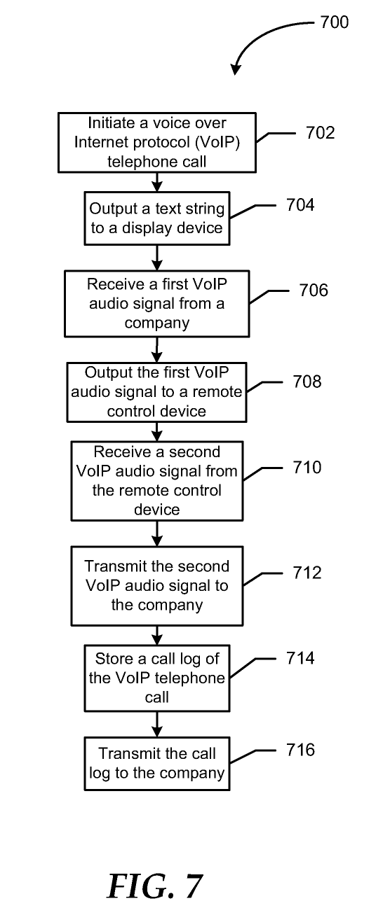

The set-top box device 124 can provide the user with the ability to talk with a customer service representative by using the remote control device 128. FIG. 7 shows a flow diagram of a method 700 for providing a telephone call through the set-top box device. At block 702, a VoIP telephone call is initiated. A text string is output to a display device at block 704. The text string can indicate that the VoIP telephone call is being initiated with a company. At block 706, a first VoIP audio signal is received from the company. The first VoIP audio signal is output to a remote control device at block 708. At block 710, a second VoIP audio signal is received from the remote control device. The second VoIP audio signal is transmitted to the company at block 712. At block 714, a call log of the VoIP telephone call is stored. The call log is transmitted to the company at block 716.

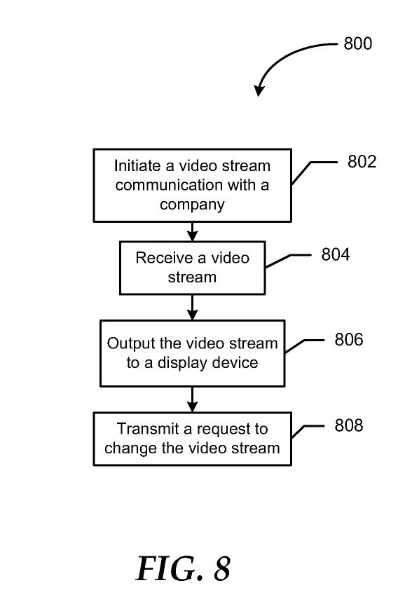

The user can also navigate through a video catalog with the use of the remote control device 128 and the set-top box device 124. FIG. 8 shows a flow diagram of a method 800 for providing an interactive video catalog through the set-top box device. At block 802, a video stream communication is initiated with a company. A video stream is received at the set-top box from the company at block 804. The video stream can be a video catalog of products offered by the company. The video stream is output to a display device at block 806. The video stream can be displayed in a small portion of the display device along with a currently received television program from an IPTV system. At block 808, a request to change the video stream is transmitted to the company based on a control signal from the remote control device. The request can be to change the page of the video catalog.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGS. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A set-top box device comprising:
a speech recognition module configured to perform speech recognition on a voice command signal to determine an action to take in the set-top box device;
a video image recognition module connected to the speech recognition module, the video image recognition module configured recognize a display device image; and
a voice over Internet protocol bridge coupled to the video image recognition module, the voice over Internet protocol bridge configured to connect a voice telephone call from the set-top box device to a call center.

2. The set-top box device of claim 1 further comprising:
a video bridge coupled to the video image recognition module, the video bridge configured to connect a video communication between the set-top box device to the advertiser.

3. The set-top box device of claim 1 further comprising:
a wireless audio module connected to the speech recognition module, the wireless audio module configured communicate with a remote control device.

4. The set-top box device of claim 1 wherein the voice over Internet protocol bridge communicates with a remote control device.

5. The set-top box device of claim 1 wherein a video stream received from the call center is output to a display device in communication with the set-top box device.

6. A method comprising:
receiving a voice command signal from a remote control device;
performing speech recognition on the voice command signal;
determining a control request in response to the speech recognition;
storing an image of a currently displayed television advertisement;
performing image recognition on the currently displayed television advertisement; and
establishing a communication with an entity associated with the currently displayed television advertisement.

7. The method of claim 6 further comprising:
determining a telephone number displayed on the image; and
connecting with the entity through a voice over Internet protocol bridge.

8. The method of claim 7 further comprising:
receiving a first voice over Internet protocol audio signal from the entity;
outputting the first voice over Internet protocol audio signal to a user;
receiving a second voice over Internet protocol audio signal from the user; and
transmitting the second voice over Internet protocol audio signal to the entity.

9. The method of claim 7 further comprising:
determining an Internet webpage address displayed on the image; and
connecting with the entity through a video bridge.

10. The method of claim 9 further comprising:
receiving a video stream from the entity; and
outputting the video stream display device.

11. A method comprising:
receiving a voice command signal from a remote control device;
performing recognition on the voice command;
determining a control request in response to the speech recognition;
storing an image of a currently displayed television advertisement;
performing a video image recognition on the currently displayed television advertisement;
determining a telephone number displayed on the image; and
communicating with an entity associated with the advertisement through a voice over Internet protocol bridge.

12. The method of claim 11 further comprising:
receiving a first voice over Internet protocol audio signal from the entity;
outputting the first voice over Internet protocol audio signal to the remote control device;
receiving a second voice over Internet protocol audio signal from the remote control device; and
transmitting the second voice over Internet protocol audio signal to the entity.

13. The method of claim 11 further comprising:
storing a call log of a voice over Internet protocol telephone call; and
transmitting the call log to the entity.

14. The method of claim 13 wherein the call log includes a date and a time of the voice over Internet protocol telephone call.

15. The method of claim 11 further comprising:
outputting a text string to a display device, the text string indicating that the voice over Internet protocol telephone call is being connected.

16. A method comprising:
receiving a voice command signal from a remote control device;
performing speech recognition on the voice command;
determining a control request in response to the speech recognition;
storing an image of a currently displayed television advertisement;
performing a video image recognition on the currently displayed television advertisement;
determining an Internet webpage address associated with the image; and
connecting with an entity associated with the advertisement through a video bridge.

17. The method of claim 16 further comprising:
receiving a video stream from the entity; and
outputting the video stream to a display device.

18. The method of claim 17 wherein the video stream is configured to be displayed along with a currently received video stream representing a television program.

19. The method of claim 17 wherein the video stream represents a video catalog of products sold by the entity.

20. The method of claim 17 further comprising:
transmitting a request to change the video stream based on an input received from the remote control device.
